(19) United States
(12) Patent Application Publication
(10) Pub. No.: US 2011/0034195 A1
(43) Pub. Date: Feb. 10, 2011

(54) RANGING METHOD AND DEVICE

(75) Inventors: Namsuk LEE, Daejeon (KR); Sook Jin Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONIC AND TELECOMMUNICATIONS RESEARCH INSTITUTE, Daejeon (KR)

(21) Appl. No.: 12/821,500

(22) Filed: Jun. 23, 2010

(30) Foreign Application Priority Data
Aug. 4, 2009 (KR) 10-2009-0071801

(51) Int. Cl. H04W 72/00

(52) U.S. Cl. 455/509

(57) ABSTRACT

A base station generates a ranging bitmap for indicating whether a ranging code is received through a corresponding ranging channel for each ranging channel, and transmits it to terminals. The terminals check whether the ranging code is successfully transmitted through the ranging bitmap provided by the base station and ranging code identity information included in a ranging response message.

### CROSS-REFERENCE TO RELATED APPLICATION

This application claims priority to and the benefit of Korean Patent Application No. 10-2009-0071801 filed in the Korean Intellectual Property Office on Aug. 4, 2009, the entire contents of which are incorporated herein by reference.

### BACKGROUND OF THE INVENTION

(a) Field of the Invention

The present invention relates to a ranging method and device.

(b) Description of the Related Art

In a wideband wireless communication system, ranging is classified as initial ranging, periodic ranging, bandwidth request ranging, and handoff ranging. Here, the initial ranging and the handoff ranging are performed for uplink synchronization acquisition, and the periodic ranging is performed for uplink synchronization maintenance.

In the conventional wideband wireless communication system, a terminal transmits a ranging code that is selected in a random fashion for initial ranging, handoff ranging, and periodic ranging to a base station, and sets a timer to wait for a response message from the base station for a predetermined time. If it fails to receive the response message from the base station when the timer has expired, the terminal determines that transmission of the ranging code has failed because of collision or generation of errors, and retransmits the ranging code. On the contrary, when it receives the response message for the ranging code from the base station before the timer has expired, the terminal stops the timer and processes parameters such as timing, power, and frequency control included in the response message.

Bandwidth request ranging represents a process for requesting a resource used for the terminal to transmit data to the uplink, and to achieve this, the terminal transmits a bandwidth request ranging code to the base station, waits for a response message for a predetermined time, and retransmits the bandwidth request ranging code when it fails to receive the response message within the predetermined time.

Upon successfully receiving the ranging code from the terminal, the base station transmits a corresponding response message to the terminal. Here, the response message includes ranging code identity information, and the ranging code identity information includes a ranging code number received by the base station so that the terminal may identify the response message, a frame number for receiving the ranging code number, a subchannel number, and a symbol number. Therefore, the terminal compares the frame number, the subchannel number, and the symbol number used for transmitting the ranging code with the ranging code identity information included in the response message provided by the base station to determine whether the response message is transmitted to the terminal.

As described above, the terminal transmits the ranging code and waits for a corresponding response message in the wideband wireless communication system. However, when transmission of the ranging code has failed because of collision or generation of errors, the terminal does not know of failure of transmission but receives the response message from the base station for the predetermined time and checks whether the response message is transmitted to the terminal. The ranging process is delayed because of the time for the terminal to wait for the response message. Particularly, the initial ranging and the handoff ranging increase delay of the network access process because of delay of the ranging process, the periodic ranging increase delay of uplink timing control, power control, and frequency control, and generates an error during uplink data transmission. Further, the bandwidth request ranging increases delay of uplink data transmission.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a ranging method for minimizing delay caused by transmission failure of ranging codes in a wideband wireless communication system.

An exemplary embodiment of the present invention provides a ranging method of a terminal, including: transmitting a first ranging code through a first ranging channel; receiving a ranging bitmap for indicating whether a ranging code is received by a base station through at least one ranging channel including the first ranging channel from the base station; checking whether a ranging code is received by the base station through the first ranging channel based on the ranging bitmap; and retransmitting the first ranging code when there is no ranging code received by the base station through the first ranging channel.

Another embodiment of the present invention provides a ranging method of a base station, including: generating a ranging bitmap for indicating whether a ranging code is received for each at least one ranging channel; and transmitting the ranging bitmap and a ranging response message for the ranging code that is received through the at least one ranging channel.

Yet another embodiment of the present invention provides a ranging device of a terminal, including: a ranging code selector for transmitting a first ranging code to a base station through a first ranging channel; and a ranging response processor for receiving a ranging bitmap for indicating whether a ranging code is received by a base station through at least one ranging channel including a first ranging channel and receiving a ranging response message from the base station, and determining whether to retransmit the first ranging code based on the ranging bitmap and ranging code identity information that is included in the ranging response message.

Yet another embodiment of the present invention provides a ranging device of a base station, including: a ranging response controller for generating a ranging bitmap for indicating whether a ranging code is received through a ranging channel that corresponds to each of at least one ranging channel, and generating ranging code information that corresponds to the received ranging code; a MAP former for forming a MAP including the ranging bitmap; a ranging response former for generating a ranging response message based on the ranging code information; and a transmitter for transmitting the MAP and the ranging response message.

### BRIEF DESCRIPTION OF THE DRAWINGS

FIG. 1 shows a block diagram of a ranging device of a base station according to an exemplary embodiment of the present invention.

FIG. 2 shows a block diagram of a ranging device of a terminal according to an exemplary embodiment of the present invention.

FIG. 3 shows a flowchart of a ranging method by a base station according to an exemplary embodiment of the present invention.

FIG. 4 shows a flowchart of a ranging method by a terminal according to an exemplary embodiment of the present invention.

FIG. 5, FIG. 6, and FIG. 7 show ranging processes according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station (MS), the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A ranging method and device according to an exemplary embodiment of the present invention will now be described with reference to accompanying drawings.

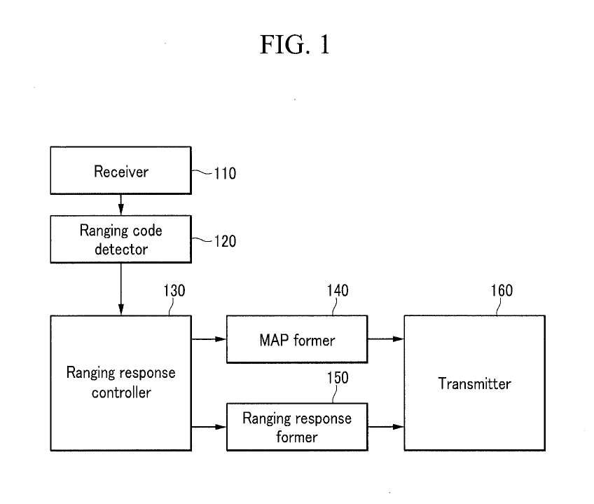

FIG. 1 shows a block diagram of a ranging device of a base station according to an exemplary embodiment of the present invention.

Referring to FIG. 1, the ranging device of a base station includes a receiver 110, a ranging code detector 120, a ranging response controller 130, a MAP former 140, a ranging response former 150, and a transmitter 160.

The ranging code detector 120 detects a ranging code for each ranging channel of an uplink frame that is received through the receiver 110. Here, the ranging channel represents a subchannel and a symbol that is allocated to the terminal so as to transmit the ranging code.

The ranging response controller 130 includes a buffer (not shown), and sequentially stores the ranging code detected by the ranging code detector 120 in the buffer and generates a ranging bitmap for each transmission of a downlink frame. Here, the respective bits included in the ranging bitmap indicate whether the ranging code is received through the corresponding ranging channel and whether the corresponding ranging response message is transmitted through the current downlink frame. That is, the ranging response controller 130 searches the ranging codes stored in the buffer for respective ranging channels, sets the bit that corresponds to the ranging channel from which the ranging code is searched from among the bits included in the ranging bitmap as 1 (or 0), and sets the bit that corresponds to the ranging channel from which no ranging code is searched as 0 (or 1).

Also, the ranging response controller 130 outputs ranging code information following the order of receiving the ranging codes so that the ranging response message may be transmitted according to the order of storing the ranging codes in the buffer, that is, in the order of receiving the ranging codes. Here, the ranging code information includes a ranging code number of the corresponding ranging code, a frame number for receiving the corresponding ranging code, a subchannel number, and a symbol number.

The MAP former 140 generates a MAP including a ranging bitmap generated by the ranging response controller 130.

The ranging response former 150 generates a ranging response message by using ranging code information that is sequentially output by the ranging response controller 130.

The transmitter 160 transmits a downlink frame including the MAP generated by the MAP former 140 and the ranging response message generated by the ranging response former 150 to the terminal.

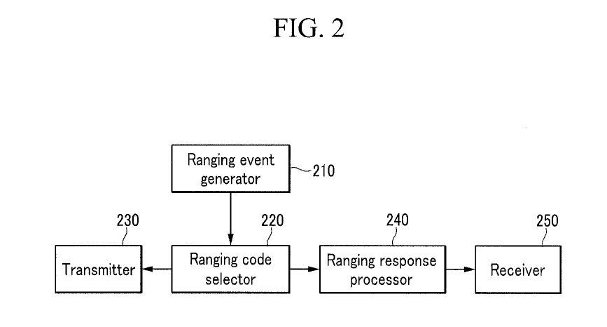

FIG. 2 shows a block diagram of a ranging device of a terminal according to an exemplary embodiment of the present invention.

Referring to FIG. 2, the ranging device of a terminal includes a ranging event generator 210, a ranging code selector 220, a transmitter 230, a ranging response processor 240, and a receiver 250.

The ranging event generator 210 generates a ranging event according to generation of uplink traffic and setting of uplink synchronization.

The ranging code selector 220 selects a ranging code, a subchannel, and a symbol for transmitting the corresponding ranging code when a ranging event occurs, and controls the transmitter 230 to include the selected ranging code in the uplink frame and transmit the same to the base station. Also, the ranging code selector 220 transmits a number of the selected ranging code, a frame number for transmitting the corresponding ranging code, a subchannel number, and a symbol number to the ranging response processor 240.

The ranging response processor 240 determines to retransmit the ranging code based on the ranging bitmap provided by the base station through the receiver 250 and ranging code identity information included in the ranging response message.

That is, the ranging response processor 240 checks whether there is a ranging code that is received by the base station through a corresponding ranging channel by checking the bit that corresponds to the ranging channel that is used by the ranging response processor 240 to transmit the ranging code from among the ranging bitmap. When the ranging code that is received by the base station through a corresponding ranging channel is found, the ranging response processor 240 receives the ranging response message and checks ranging code identity information included in the corresponding ranging response message to determine whether to retransmit the ranging code. When the ranging code that is received by the base station through a corresponding ranging channel is found, the ranging response processor 240 does not receive the ranging response message but retransmits the ranging code.

When having determined to retransmit the ranging code, the ranging response processor 240 controls the ranging code selector 220 to retransmit the ranging code.

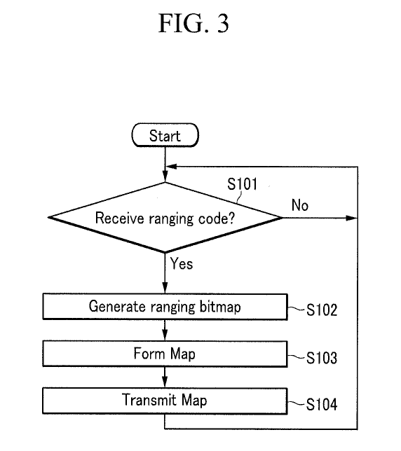

FIG. 3 shows a flowchart of a ranging method by a base station according to an exemplary embodiment of the present invention.

Referring to FIG. 3, upon receiving the ranging code of the terminal through the receiver 110 (S101), the ranging response controller 130 sequentially stores it in the buffer, and generates a ranging bitmap for indicating a state of receiving the ranging code per ranging channel (S102).

The MAP former 140 forms a MAP including the ranging bitmap generated by the ranging response controller 130 (S103), and the transmitter 160 includes the MAP in the downlink frame and transmits the same (S104). When there is a ranging code provided by the terminal, the ranging response former 150 generates a ranging response message, and the transmitter 160 includes the ranging response message and the MAP in the downlink frame and transmits the same.

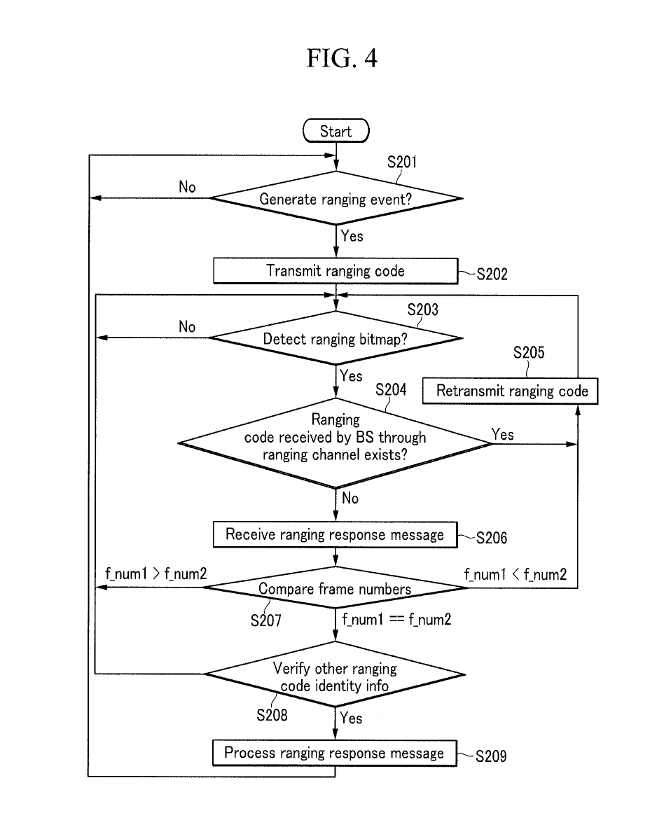

FIG. 4 shows a flowchart of a ranging method by a terminal according to an exemplary embodiment of the present invention.

Referring to FIG. 4, when the ranging event generator 210 generates a ranging event because of uplink traffic generation and uplink synchronization (S201), the ranging code selector 220 selects the ranging code corresponding to the ranging event, and transmits the selected ranging code to the base station through the transmitter 230 (S202).

When a ranging bitmap is detected from the downlink frame MAP provided by the base station (S203), the ranging response processor 240 checks whether a ranging code is received by the base station through the corresponding ranging channel by checking the bit that corresponds to the ranging channel that is used by the terminal to transmit the ranging code from among the bits that are included in the ranging bitmap (S204).

When it is determined that no ranging code is received by the base station through the corresponding ranging channel, the ranging response processor 240 controls the ranging code selector 220 to retransmit the ranging code (S205). On the contrary, when it is determined that a ranging code is received by the base station through the corresponding ranging channel, the ranging response processor 240 receives a ranging response message from the base station through the receiver 250 (S206), and compares the frame number (f_num1) through the terminal has transmitted the ranging code and the frame number (f_num2) that is included in ranging code identity information of the ranging response message received by the terminal (S207).

When the two frame numbers are found to be the same (f_num1==f_num2), the ranging response processor 240 compares the frame number with residual information included in the ranging code identity information, that is, a ranging code number, a subchannel number, a ranging code number for the terminal to transmit the symbol number, a subchannel number that is used to transmit the ranging code, and a symbol number to verify whether the ranging code identity information corresponds to the ranging code transmitted by the ranging response processor 240 (S208). When the residual ranging code identity information is verified, the ranging response processor 240 determines that the ranging code has been successfully transmitted and processes the received ranging response message (S209). However, when the residual ranging code identity information is determined to not correspond to the ranging code transmitted by the ranging response processor 240, the ranging response processor 240 discards the received ranging response message and stands by for the next ranging bitmap and ranging response message.

When the frame number that is used by the terminal to transmit the ranging code is greater than the frame number that is included in the ranging code identity information (i.e., f_num1>f_num2), the ranging response processor 240 discards the received ranging response message and stands by for the next ranging bitmap and ranging response message. When the frame number used to transmit the ranging code is less than the frame number included in the ranging code identity information (i.e., f_num1<f_num2), the ranging response processor 240 determines that transmission of the ranging code has failed, and controls the ranging code selector 220 to retransmit the ranging code.

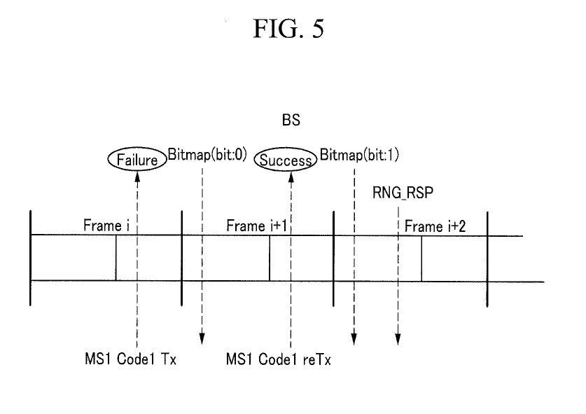

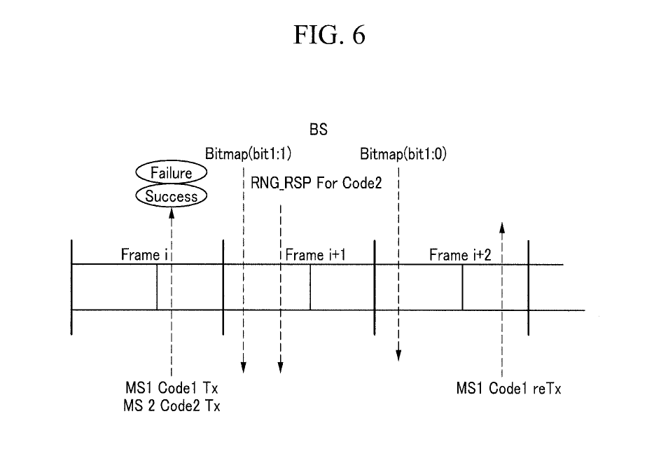

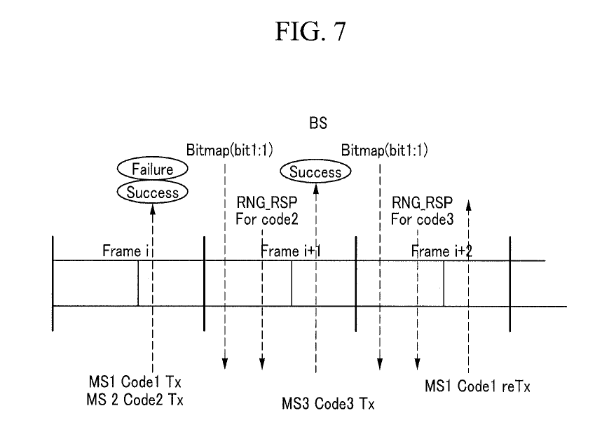

FIG. 5, FIG. 6, and FIG. 7 show ranging processes according to an exemplary embodiment of the present invention, exemplifying one ranging channel.

Referring to FIG. 5, the terminal 1 MS1 has transmitted the ranging code Code1 at the i-th frame, and the base station BS has failed to receive it. Hence, the base station sets the bit of the ranging bitmap to be 0 and transmits it at the (i+1)-th frame Frameᵢ₊₁. Having received it, the terminal 1 determines that transmission of the ranging code Code1 has failed by checking the ranging bitmap, and retransmits the ranging code Code1 at the (i+2)-th frame Frameᵢ₊₂.

The base station successfully receives the ranging code Code1 from the terminal 1, sets the bit of the ranging bitmap to be 1, and transmits it. Accordingly, the terminal 1 checks whether a ranging code is actually received by the base station through the ranging channel according to the ranging bitmap provided by the base station, and receives a ranging response message RNG_RSP.

Referring to FIG. 6, the terminal 1 MS1 and the terminal 2 MS2 transmit the ranging codes Code1 and Code2 at the i-th frame, and the base station successfully receives the ranging code Code2 of the terminal 2. Therefore, since a ranging code is received through the ranging channel, the base station sets the bit of the ranging bitmap to be 1, and transmits it together with the ranging response message RNG_RSP for Code2 at the (i+1)-th frame Frameᵢ₊₁. Here, the ranging response message includes a number of the Code2, a frame number for receiving the Code2, a subchannel number, and a symbol number.

Therefore, the terminal 2 confirms that the bit of the ranging bitmap provided by the base station is set to be 1 and receives a ranging response message transmitted at the (i+1)-th frame Frameᵢ₊₁, and then confirms that the corresponding ranging message is transmitted to the terminal 2 through the ranging code identity information included in the received ranging response message and processes the ranging response message.

On the contrary, the terminal 1 checks whether the bit of the ranging bitmap is set to be 1, receives the ranging response message transmitted at the (i+1)-th frame Frameᵢ₊₁, and confirms that the corresponding ranging message is not transmitted to the terminal 1 through ranging code identity information included in the received ranging response message. Therefore, the terminal 1 receives the ranging response message in the next frame Frameᵢ₊₂.

The base station sets the bit of the ranging bitmap to be 0 and transmits it to the terminal since no ranging code is received at the (i+2)-th frame Frameᵢ₊₂. Accordingly, the terminal 1 having received the same confirms that transmission of the ranging code has failed through the ranging bitmap and retransmits the ranging code Code1.

Referring to FIG. 7, the terminal 1 MS1 and the terminal 2 MS2 transmit the ranging codes Code1 and Code2 at the i-th frame Frameᵢ, and the base station successfully receives the ranging code from the terminal 2. Therefore, the base station sets the bit of the ranging bitmap to be 1, and transmits it together with the ranging response message RNG_RSP for Code2 at the (i+1)-th frame Frameᵢ₊₁.

Hence, the terminal 1 checks that the bit of the ranging bitmap is set to be 1, and receives the ranging response message that is transmitted at the (i+1)-th frame Frameᵢ₊₁. However, the terminal 1 confirms that the corresponding ranging message is not transmitted to the terminal 1 through the ranging code identity information included in the ranging response message, and continues to receive the ranging response message at the next frame Frameᵢ₊₂.

The base station successfully receives the ranging code Code3 from the terminal 3 MS3 at the (i+1)-th frame Frameᵢ₊₁, and transmits the ranging bitmap that is set to be 1 and the ranging response message RNG_RSP for Code3 at the (i+2)-th frame Frameᵢ₊₂. Here, the frame number of the ranging code identity information included in the ranging response message for Code3 is i+1.

Hence, the terminal 1 confirms that the bit of the ranging bitmap is set to be 1, and receives the ranging response message at the (i+1)-th frame Frameᵢ₊₁. However, since the frame number included in the received ranging response message is i+2 and is greater than the frame number i that is used for the terminal 1 to transmit the ranging code, the terminal 1 determines that transmission of the ranging code has failed and retransmits the ranging code Code1.

As described, the time for the ranging process is reduced since it is possible for the terminal to determine failure of transmission of the ranging code without waiting for receipt of the ranging response message for a predetermined time frame in the exemplary embodiment of the present invention.

According to an embodiment of the present invention, it is possible for the terminal to quickly determine transmission success or failure of the ranging code transmitted by the terminal. Accordingly, the time delay generated in the ranging process is reduced, the time for uplink synchronization is reduced in the cases of the initial ranging and the handoff ranging, and transmission delay of uplink data is reduced in the case of the bandwidth request ranging.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A ranging method of a terminal, comprising:
transmitting a first ranging code through a first ranging channel;
receiving a ranging bitmap for indicating whether a ranging code is received by a base station through at least one ranging channel including the first ranging channel from the base station;
checking whether a ranging code is received by the base station through the first ranging channel based on the ranging bitmap; and
retransmitting the first ranging code when no ranging code is received by the base station through the first ranging channel.

2. The ranging method of claim 1, further including:
receiving a ranging response message from the base station when a ranging code is received by the base station through the first ranging channel; and
determining whether the first ranging code is successfully transmitted based on ranging code identity information that is included in the ranging response message.

3. The ranging method of claim 2, wherein
the determining of whether the first ranging code is successfully transmitted includes
determining that the first ranging code is successfully transmitted when the ranging code identity information corresponds to the first ranging code.

4. The ranging method of claim 2, wherein
the determining of whether the first ranging code is successfully transmitted includes
discarding the ranging response message when a first frame number that is included in the first ranging code identity information corresponds to a second frame number that is used to transmit the first ranging code and information other than the first frame number from among information that is included in the first ranging code identity information does not correspond to the first ranging code.

5. The ranging method of claim 2, wherein
the determining of whether the first ranging code is successfully transmitted includes
retransmitting the first ranging code when a first frame number that is included in the ranging code identity information is greater than a second frame number that is used to transmit the first ranging code.

6. The ranging method of claim 2, wherein
the determining of whether the first ranging code is successfully transmitted includes
discarding the ranging response message when a first frame number that is included in the ranging code identity information is less than a second frame number that is used to transmit the first ranging code.

7. The ranging method of claim 1, wherein
the checking includes
determining that a ranging code is received by the base station through the first ranging channel when a value of a bit that corresponds to the first ranging code from among at least one bit that is included in the ranging bitmap has a first value.

8. A ranging method of a base station, comprising:
generating a ranging bitmap for indicating whether a ranging code is received for each of at least one ranging channel; and
transmitting the ranging bitmap and a ranging response message for the ranging code that is received through the at least one ranging channel.

9. The ranging method of claim 8, wherein
the transmitting includes
including the ranging bitmap in a MAP of a downlink frame and transmitting the same.

10. The ranging method of claim 8, wherein
the ranging response message includes at least one of a number of the corresponding ranging code, a frame number that is used to receive the corresponding ranging code, a subchannel number, and a symbol number.

11. A ranging device of a terminal, comprising:
a ranging code selector for transmitting a first ranging code to a base station through a first ranging channel; and
a ranging response processor for receiving a ranging bitmap for indicating whether a ranging code is received by a base station through at least one ranging channel including a first ranging channel and a ranging response message from the base station, and determining whether to retransmit the first ranging code based on the ranging bitmap and ranging code identity information that is included in the ranging response message.

12. The ranging device of claim 11, wherein
the ranging response processor receives the ranging response message when it is determined that a ranging code is received by the base station through the first ranging channel based on the ranging bitmap.

13. The ranging device of claim 12, wherein
the ranging response processor determines whether to retransmit the first ranging code based on the ranging code identity information when receiving the ranging response message.

14. The ranging device of claim 13, wherein
the ranging response processor controls the ranging code selector so as to retransmit the first ranging code when a frame number that is included in the ranging code identity information is greater than a number of a frame that is used to transmit the first ranging code.

15. The ranging device of claim 11, wherein
the ranging code selector is controlled to retransmit the first ranging code when it is determined that no ranging code is received by the base station through the first ranging channel.

16. The ranging device of claim 11, wherein the ranging device further includes a ranging event generator for generating a ranging event, and
the ranging code selector selects the first ranging code corresponding to the ranging event.

17. A ranging device of a base station, comprising:
a ranging response controller for generating a ranging bitmap for indicating whether a ranging code is received through a ranging channel that corresponds to each of at least one ranging channel, and generating ranging code information that corresponds to the received ranging code;
a MAP former for forming a MAP including the ranging bitmap;
a ranging response former for generating a ranging response message based on the ranging code information; and
a transmitter for transmitting the MAP and the ranging response message.

18. The ranging device of claim 17, wherein
the ranging response controller sequentially outputs the ranging code information to the ranging response former based on an order of receiving ranging codes.

19. The ranging device of claim 17, wherein
the ranging code information includes at least one of a ranging code number of a corresponding ranging code, a frame number, a subchannel number, and a symbol number.
